(19) United States
(12) Patent Application Publication
(10) Pub. No.: US 2010/0312815 A1
(43) Pub. Date: Dec. 9, 2010

(54) DATE COMMUNICATION PROCESSING DEVICE AND METHOD

(76) Inventor: Masaki Uekubo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/735,707

(22) PCT Filed: Mar. 25, 2009
(86) PCT No.: PCT/JP2009/055893

§ 371 Date: Aug. 10, 2010

(30) Foreign Application Priority Data
Mar. 26, 2008 (JP) 2008-080757

(51) Int. Cl. G06F 15/16

(52) U.S. Cl. 709/201

(57) ABSTRACT

A data communications processor which mediates data sending and receiving in an embedded system is provided, wherein it avoids increase of processing due to accretion of number of communication data, disuses any resources for individual management of deadline for each data, and executes deadline management without a starvation. It does not execute receiving process successively for each communication datum; however, it executes receiving process for each assembled data accumulation partial area data as a whole for each prefixed period. In addition, a plurality of data accumulation partial areas in the data accumulating means 220, which is separated for each deadline, are executed batch receiving process respectively at the period according to the relative deadline time.

### TECHNICAL FIELD

The present invention relates to a buffer for temporarily storing data when executing data sending and receiving in an apparatus, and in particular, relates to a data communications processor and a data communications method for communicating data among a plural of processors in an embedded system.

### BACKGROUND ART

With recent progresses in digital technologies development, processors are used for various electronic apparatuses including one for specific applications. Data processing system used for these specific applications are called embedded systems, and it executes requested processes as an entire system by combining software process using processors and dedicated hardware engines.

In such kind of embedded systems, it is necessary to execute operations that are synchronizing with outside of the system, and a product design in consideration of real time capability is requested. The real time capability means whether the occurrence time of the event which is created in a real product meets within time range defined by a specification or not. In this case, a hard real-time system means that a value of the event is completely lost under a condition that the event is not created within a time range which is strictly defined by a specification, and a soft real-time system means that a value of the event is increased under a condition that the event is created within a specific time range which is strictly defined by a specification and is not completely lost the value but is damaged accordingly even if the event is not created within the time range.

Further, a deadline is in one of concrete indexes in relation with the real time capability. The deadline means a worst time that a requested operation needs to be completed. When it represents the deadline as a concrete value, an absolute deadline time designated by the absolute time, and a relative deadline time designated by the relative time, is used. Although OS (Operating System) is commonly used for general-purpose processing systems including PCs (Personal Computer), recently, it becomes common to use RTOS (Real Time Operating System) for embedded systems where the real time capability is incorporated easily and a plurality of tasks are executed in time division.

Further, recently, a semiconductor device such as SoC (System on Chip) in which hardware blocks such as processors and dedicated hardware engines are mounted on single chip, is started to use widely. In addition, it is increasing to adopt multi-core processors for commercial products in which a plurality of processors are allocated in an apparatus or on a semiconductor chip aiming for improving data processing performance and low power consumption. In these systems, a plurality of processors are communicating each other and executing requested processes as the entire system.

As it has described above, a performance required for the recent years' embedded system includes meeting the real time capability as well as enhancing absolute value of data processing speed. For these reasons, for the system of adopting the multi-core processor configuration, real time capability is requested even for communications when communicating between the processor.

For example, following to a means for the securing the real time capability described in a third page and FIG. 1 in a patent document 1, it is disclosed a high processing priority queue and a low processing priority queue and en-queuing processes that require the real time capability to the high processing priority queue. As a result, a process requesting the real time capability is executed with priority without affecting influence from other processes, and it is easy to achieve the real time capability.

Following to the means described in a page 14 and FIG. 1 in a patent document 2, a method is disclosed including management of the deadline for each data which is an index of the real time capability, in which the relative deadline time is successively calculated on each data by the difference between the absolute deadline time and the present time, and executes the data before whose relative deadline time is expired.
Patent document 1: Japanese Patent Application Laid-Open No. 1995-030946
Patent document 2: Japanese Patent Application Laid-Open No. 2000-163222

### DESCRIPTION OF THE INVENTION

### Problems to be Solved by the Invention

However, an issue is arisen when it secures real time performance in an apparatus disclosed in the patent document 1.

Following to the method of using a real time queue and a normal queue in parallel, an issue is caused by priority based management where the relative deadline time that each data has is not considered, because priority of receive operation is always gave to the real time queue at a data receiving side, and reception order among data is decided according only to a relative processing sequence specified by a data sending side.

In this case, if high priorities data are continually exist in a buffer between the sending side and the receiving side, then a state of the starvation is initiated where low priority data is hard to be executed. For example, considering a case that a first data that is in a receive waiting status for a long time and close to the absolute deadline time because of the lower priority, and a second data that has a enough spare time before the absolute deadline time because the elapsed time from the transmission time has passed shortly because of the high priority, the second data that have enough spare time before the absolute deadline time is executed the receive process first.

Moreover, an apparatus disclosed in the patent document 2 has an issue when it secures the real time performance.

The issue is caused by requiring large overhead on hardware resource and time allowance such as a storage area for managing the deadline for each communication data and a calculation resource for calculating remaining time before the deadline from the current time to the deadline time. According to the method, a processing margin of an entire system tends to be declined according to number of data under communication processing is increased, and it scares a scalability to number of communication data, and a limit value of possible traffic volume tends to become low.

Further, in general, in a case that a receive process is executed independently on each communicating data, receive processing time increases in proportional to number of communicating data. For example, when it composes that an interrupt signal between the central processor and an interrupt handler is initiated at the receiving side whenever the communication data occur, then total amount of overhead which is needed in order to initiates the interrupt handler is increased in proportional to number of the communicating data. As a result, execution time margin of the central processor at the receiving side is decreased according to increase of number of the communication data, and it seems as if apparent data processing throughput of the entire system is decreased. Accordingly, a configuration wherein number of communicating data does not affect performance of the entire system is desired.

The present invention has been made in view of the above-mentioned issues, and objectives are to provide the data communications processor which includes avoiding increase of the communication processing time in proportional with increase number of the communication data, managing the deadline attached to each datum, avoiding a starvation which occurs on a part of data, and minimizing physical and temporal overhead for the data communication, when communicating data in an embedded system.

### Means for Settling the Problem

In order to achieve the above-mentioned objectives, the present invention has the following features.

A data communications processor according to the present invention characterized by comprising a data accumulating means which stores input data in a data accumulation partial area, a data retrieving means which retrieves data from the data accumulating means, and a reception timing creating means which generates a timing at a predetermined period, wherein the data retrieving means successively retrieves whole data from the data accumulation partial area at a time designated by the reception timing creating means.

The data communications processing method according to the present invention characterized by including a step in which distributes an inputted data to a plurality of groups based on the inputted deadline value, a step in which accumulates the data that is distributed to the plurality of group, a step which creates timings so as period of multiply of 2 and not overwrap for each plurality of group, and a step in which outputs whole data included in the group at the generated timing where the timing is related with the group.

### EFFECT OF THE INVENTION

According to the present invention, when communicating data in an embedded system, it can provide a data communications processor wherein it avoids increase of communication processing time that increases in proportional with number of the communication datum, manages a deadline given for each data, avoids that a starvation occurs to a part of the data, and minimizes physical and temporal overhead for the data communication.

### MOST PREFERRED MODE FOR CARRYING OUT THE INVENTION

Next, embodiments for carrying out the present invention are described in detail by referring to drawings.

### First Embodiment

FIG. 1 is a block diagram showing a composition of an entire system according to a first embodiment of the present invention. The entire system according to the embodiment is a configuration where a first central processor 100, a data communications processor 200, and a second central processor 300 are connected.

FIG. 2 is a block diagram showing a composition of the data communications processor 200 according to the first embodiment of the present invention. The data communications processor 200 includes a data input controlling means 210, a data accumulating means 220, a data retrieving means 230, and a reception timing creating means 240.

The data communications processor 200 is connected with the first central processor 100 and inputs an input structural data including communication data and deadline information as a data structure input signal 2001. Further, it is also connected with the second central processor 300 and outputs the communication data as a data output signal 2010, and outputs a data reception request as a data reception requesting signal 2011.

FIG. 3 is a block diagram showing a composition of the data input controlling means 210 according to the first embodiment of the present invention. The data input controlling means 210 includes a data storage location selecting means 211 and a multiplexer for data storage 212.

The data input controlling means 210 is connected with the first central processor 100 and inputs the input data structure 2001 that includes the data and the deadline information. The data input controlling means 210 is connected with the data accumulating means 220 and outputs data for each data accumulation partial area by signal for data accumulations 2002-2004. Further, the multiplexer for data storage 212 is connected with the data storage location selecting means 211, inputs a storage data by a signal for data storage 2101, and inputs the data storage partial area selection information by a data storage partial area selecting signal 2102.

FIG. 4 is a block diagram showing a composition of the data accumulating means 220 according to the first embodiment of the present invention. The data accumulating means 220 includes a first data accumulation partial area 221, a second data accumulation partial area 222, and a third data accumulation partial area 223.

The data accumulating means 220 is connected with the data input controlling means 210 and inputs the data for each data accumulation partial area by the signal for data accumulations 2002-2004. The data accumulating means 220 is connected with the data retrieving means 230 and outputs the data for each data accumulation partial area by accumulated data signals 2005-2007.

FIG. 5 is a block diagram showing a composition of the data retrieving means 230 according to the first embodiment of the present invention. The data retrieving means 230 includes a multiplexer for data retrieve 231.

The data retrieving means 230 is connected with the second central processor 300 and outputs the accumulating data by the data output signal (i.e. communication data signal) 2010. The data retrieving means 230 is connected with the reception timing creating means 240 and controlled by the input of a multiplexer switching signal for data retrieve 2009.

FIG. 6 is a block diagram showing a composition of the reception timing creating means 240 according to the first embodiment of the present invention. The reception timing creating means 240 includes a periodic event creating means 241, a signal count measuring means 242, a storage area selection determining means 243, and a reception timing generating means 244.

The signal count measuring means 242 is connected with the periodic event creating means 241 and inputs a period timing from the periodic event creating means 241 by a periodic timing signal 2401. In addition, the storage area selection determining means 243 is connected with the data accumulating means 220 and inputs each data accumulation partial area data count information by each data accumulation partial area data count information signal 2008. Further, the storage area selection determining means 243 is connected with the data retrieving means 230 and outputs a multiplexer switching signal for data retrieve 2009. Moreover, the storage area selection determining means 243 is connected with the reception timing generating means 244 and outputs the data reception requesting (or canceling) signal 2011. Furthermore, the reception timing generating means 244 is connected with the periodic event creating means 241 and inputs a periodic timing signal 2401.

Although number of the data accumulation partial area is set to three for convenience in the explanation, it can apply similarly even when the number of the data accumulation partial area is set to N and also number of the associated parts is set to N, where N is a nature number.

Next, it describes a process flow of the data input controlling means 210 using a flowchart shown in FIG. 7. When information on data and deadline is inputted by the data structure input signal 2001 (Step S701), the data input controlling means 210 determines which of data accumulation partial areas 211-213 it input the data based on information of the deadline (Step S702). At that time, because a data retrieving period is defined on each data accumulation partial areas 211-213 statically in advance by the data retrieving means 230, the data input controlling means 210 compares the period with the relative deadline time, selects the data accumulation partial areas 211-213 in which the relative deadline time meets within range of the value of the period (Step S702), and stores the data into the corresponding data accumulation partial areas 211-213 (Step S703).

Next, it describes an operation of the reception timing creating means 240 using a flowchart shown in FIG. 8. The periodic event creating means 241 is consisting of a hardware timer as an example, and the signal count measuring means 242 counts the periodic signal which is outputted from the timer (Steps S801-S802). Because the count value and which of data accumulation partial areas 211-213 it outputs the data is allocated statically, one of them is selected (Step S803). And it requests to the second central processor 300 on receiving whole data from the selected data accumulation partial area among the data accumulation partial areas 211-213 by the data reception requesting signal 2011 (Step S804). The second central processor 300, after received the data reception requesting signal 2011, receives the whole data of the data accumulation partial area via the data retrieving means 230 (Step S805).

Next, by using a timing chart shown in FIG. 9, it describes a method of how to allocate reception timing so as not to overwrap for each period in the storage area selection determining means 243. The periodic event creating means 241 creates a periodic timing at a constant interval. Horizontal axis of the FIG. 9 indicates a time axis and upper part of the figure indicates count values of the timing which is created periodically from the periodic event creating means 241. A reception timing from a first accumulation partial area is a time when the least significant bit (i.e. bit [0]) is 1 when the count value is represented in binary format. A reception timing from a second accumulation partial area is a time when second bit from the least significant bit (i.e. bit [1]) is 1 and the least significant bit (bit [0]) is 0 when the count value is represented in binary format. A reception timing from a third accumulation partial area is a time when third bit from the least significant bit (i.e. bit [2]) is 1 and the second bit from the least significant bit (bit [1]) is 0 at the same time the least significant bit (bit [0]) is 0 when the count value is represented in binary format. In the same manner, the reception timing from a N-th accumulation partial area is a time when N-th bit from the least significant bit (i.e. bit [N-1]) is 1 and from bit 0 to bits [N-2] is all 0 when the count value is represented in binary format, for any natural number N.

Further, for example, a process interval of the periodic event creating means 241 assumes to be approximately 1 ms, as is usually used for RTOS.

Following are summaries of the embodiment mentioned above.

The data communications processor 200 according to the embodiment comprising the data accumulating means 220 which stores the input data in a plurality of data accumulation partial areas, the data input controlling means 210 which decides which of the data accumulation partial area that are included in the data accumulating means it accumulates the data based on the inputted deadline value, the data retrieving means 230 which retrieves the data from the data accumulating means, and the reception timing creating means 240 which generates a timing by the period of the multiply by 2 and not overwrapped each other for each data accumulation partial area, wherein it complete reception with minimum overhead by the time of the absolute deadline time for the inputted communication data characterized in that the data retrieving means 230 successively retrieves whole data from the data accumulation partial area 220 at the time designated by the reception timing creating means 240

Further, in the data communications processor 200 according to the embodiment, a plurality of data accumulation partial areas exist in the data accumulation area 220, and respective receiving period is assigned to the data accumulation area in advance respectively wherein, communication processing is executed so as a time until reception of the data, which is received in period T at the data accumulation partial area, is set to T/2 as the expected value and T as the worst value.

Next, it describes accomplished merits according to the embodiment.

The first merit is, even when a number of data that is equal to a communication object increases, it can prevent proportional increase of overhead due to the receiving process. This is because, by executing a batch receiving process of the data for each period, number of times that it initiates the process flow for executing receiving process per prefixed interval becomes constant and is independent from number of datum.

The second merit is, by executing the deadline management on each data, it can provide the data communications processor capable of avoiding occurrence of the starvation. This is because, execution of the receiving process always has completed within a set period even for a communication data with long relative deadline time.

The third merit is, even though it can realize execution of the deadline management for each data, it can provide the data communications processor capable of suppressing in minimum the overhead for the management. This is because, it does not need to keep the deadline management information for each data, and the receiving period corresponding to the deadline is assigns for each queue. In accordance with that, the processing resource is not required for successively calculating the absolute deadline time for each data.

The forth merit is, by providing a process distribution at the reception as well as providing a data communications processor which can improve the process anticipation capability, it can contribute to the improvement of the real time capability. This is because, by not overwrapping the reception time between each data areas, it can distribute the process that is executed after the reception, it can predict easily at which time the accompanying process is initiated since it can calculate on which data is received at which timing by the count value of the periodic event, and it can contribute to the improvement of the real time capability.

### Second Embodiment

Next, it describes a best mode for carrying out the second embodiment of the present invention in detail by referring to a drawing.

FIG. 10 is a flowchart showing a process of the interrupt handler in the data communications processor according to the second embodiment of the present invention, wherein the periodic event creating means 241 is implemented by a hardware timer and means other than the periodic event creating means 241 in the reception timing creating means 240 are realized by the interrupt handler in the second central processor 300.

When a receiving side processor receives a timer interrupt signal, then it suspends the process which is executing according to the need, and initiates the interrupt handler corresponding to the timer interrupt signal (Step S1001). A counter is installed in the interrupt handler, and it calculates based on the counter from which data accumulation partial area it retrieves whole data at a time when the timer interruption is initiated (Step S1002). The period of multiply by 2 is assigned to each data accumulation area and, as is similar to the first embodiment in this case, it can calculate from which accumulation partial area it retrieves the data using the binary counter. The whole data is retrieved from the calculated accumulation partial area (Step S1003), and is sent to a message communication mechanism and the others that are provided by RTOS in advance (Step S1004).

### Third Embodiment

Next, it describes a best mode for carrying out the third embodiment of the present invention in detail by referring to a drawing.

FIG. 11 is a block diagram showing a general composition of the data communications processor according to the third embodiment of the present invention. In the first and the second embodiment, although it has been described as the data communication between different central processor 100 and 300, according to the third embodiment, as a means of task scheduling in RTOS, RTOS 602 in the central processor 500 serves both the sending source and the receiving source instead and the task identification is used as the communication data. Further, in FIG. 11, a composition including a hardware timer 510 and a interrupt handler 601 as a reception timing creating means is indicated, that is the same as the second embodiment.

When a plurality of tasks that is to be executed within a predetermined deadline occur successively, RTOS 602 inputs the respective task identification and the deadline value to the buffer 400. The task identification that is accumulated in the task identification storing means 420 reports to RTOS as a receiving request at a timing initiated by the predetermined period, and RTOS executes tasks successively by retrieving the task identification from the relevant task identification accumulation partial area.

Further, this application claims priority from Japanese Patent Application No. 2008-080757, filed on Mar. 26, 2008, the contents of which are incorporation herein by the reference in their entirety.

### THE AVAILABILITY IN THE INDUSTRY

Examples of application of the present invention include such as a data communication among central processors in an embedded system with multi-core configuration of which real time capability is required, a message passing mechanism represented by such as data communication among a plurality of tasks in a single central processor, a buffer between a central processor and peripheral devices including human interfaces and storage units, and a task queue in the task scheduler in RTOS which performs task process management.

### BRIEF DESCRIPTION OF THE DRAWINGS

FIG. 1 is a block diagram showing a composition of an entire system according to a first embodiment of the present invention.

FIG. 2 is a block diagram showing a composition of a data communications processor according to the first embodiment of the present invention.

FIG. 3 is a block diagram showing a composition of the data input controlling means 210 in the data communications processor according to the first embodiment of the present invention.

FIG. 4 is a block diagram showing a composition of the data accumulating means 220 in the data communications processor according to the first embodiment of the present invention.

FIG. 5 is a block diagram showing a composition of the data retrieving means 230 in the data communications processor according to the first embodiment of the present invention.

FIG. 6 is a block diagram showing a composition of the reception timing creating means 240 in the data communications processor according to the first embodiment of the present invention.

FIG. 7 is a flowchart showing a process flow of the data input controlling means 210 in the data communications processor according to the first embodiment of the present invention.

FIG. 8 is a flowchart showing a process flow of the data retrieving means 230 in the data communications processor according to the first embodiment of the present invention.

FIG. 9 is a timing chart showing an operation of the reception timing creating means 240 in the data communications processor according to the first embodiment of the present invention.

FIG. 10 is a flowchart showing a process flow of the interrupt handler 601 in the data communications processor according to a second embodiment of the present invention.

FIG. 11 is a block diagram showing a composition in the data communications processor according to a third embodiment of the present invention.

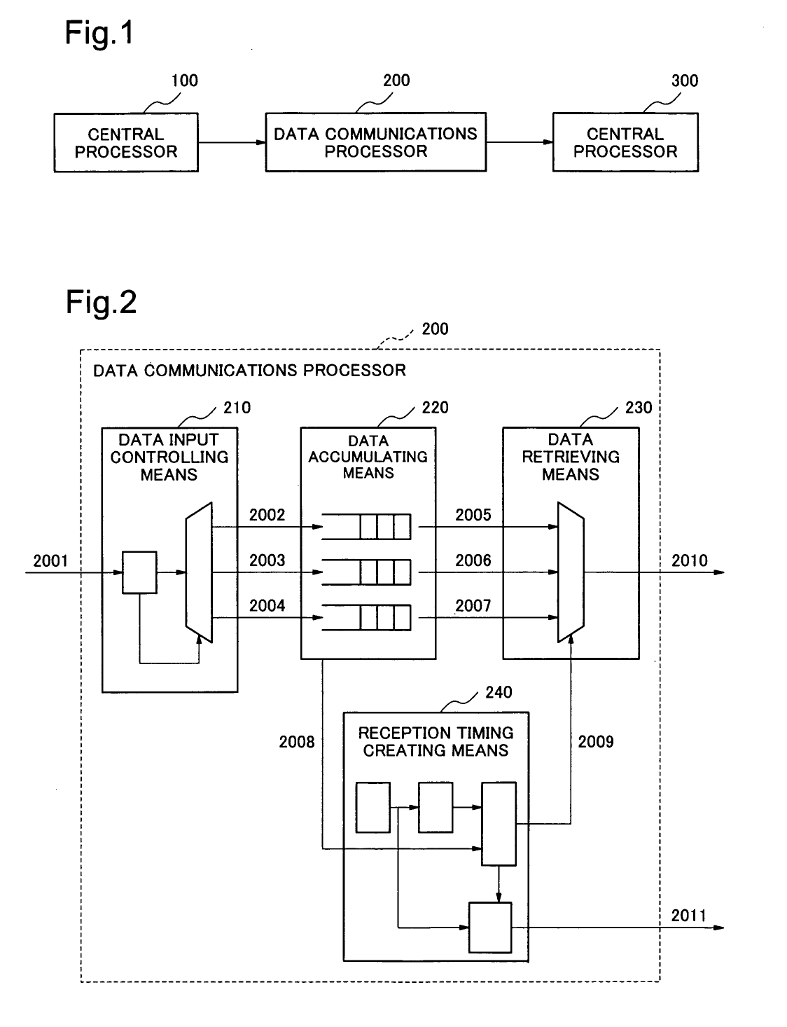

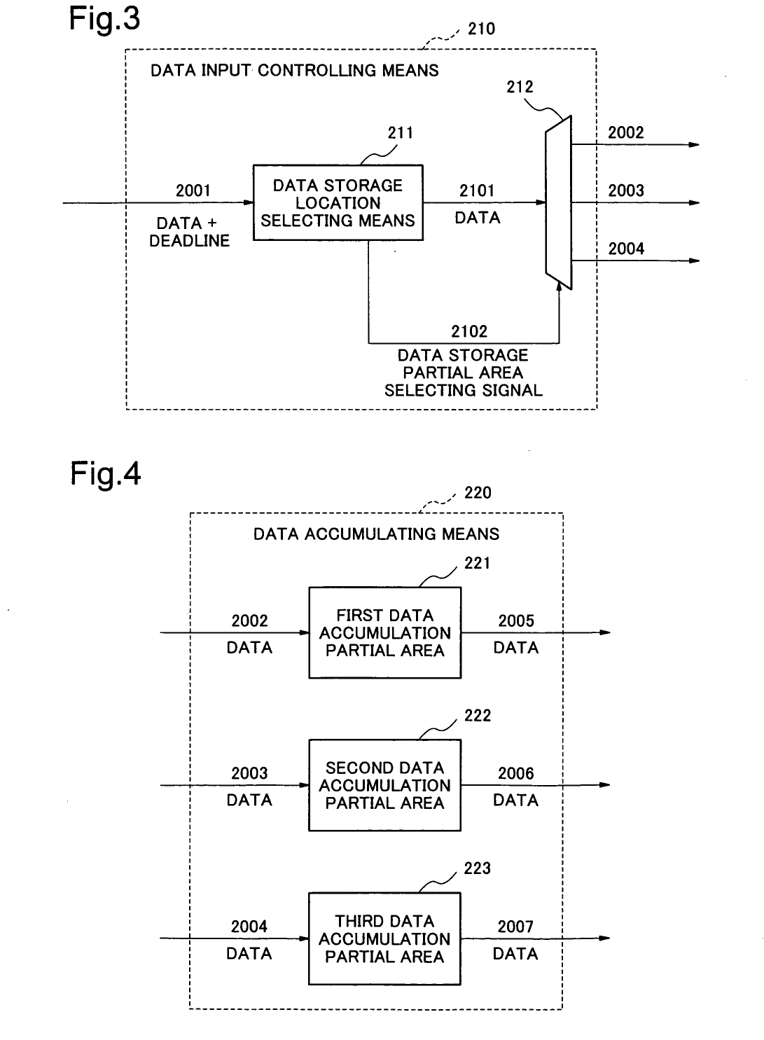

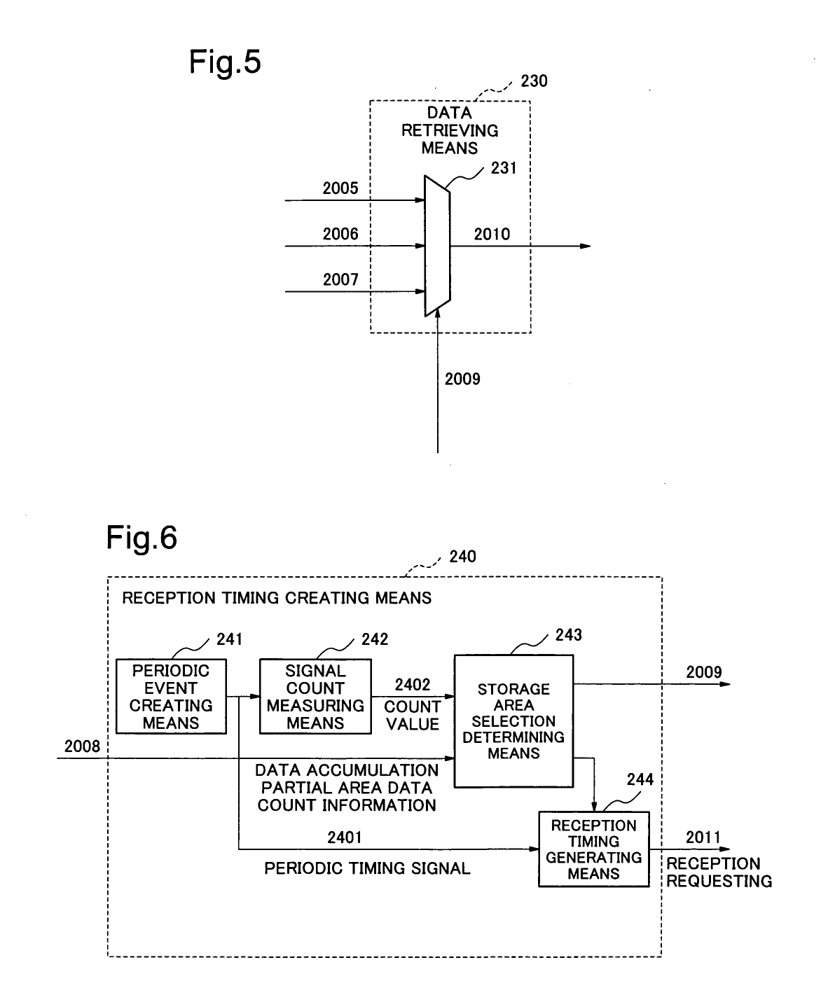

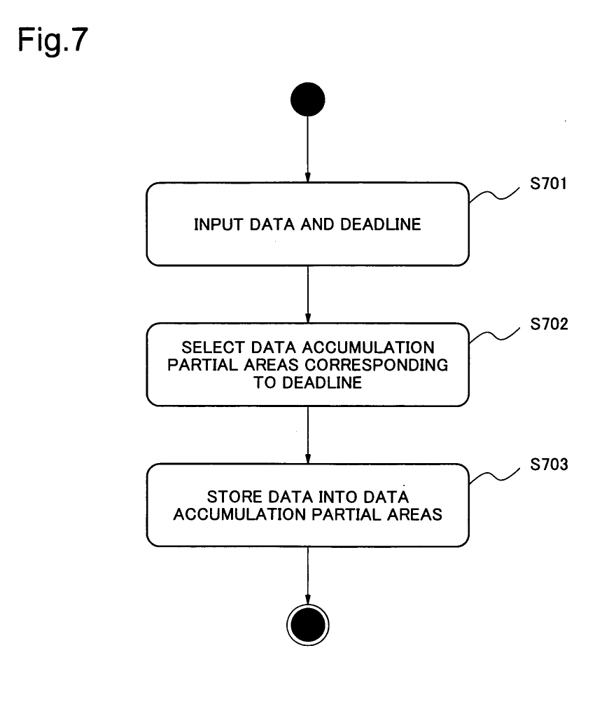

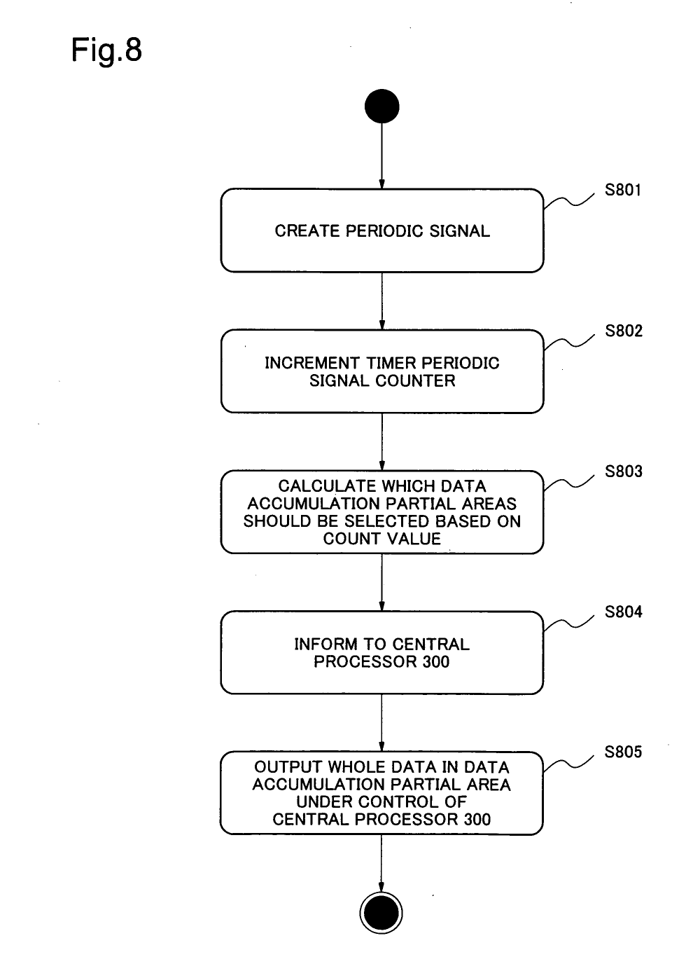

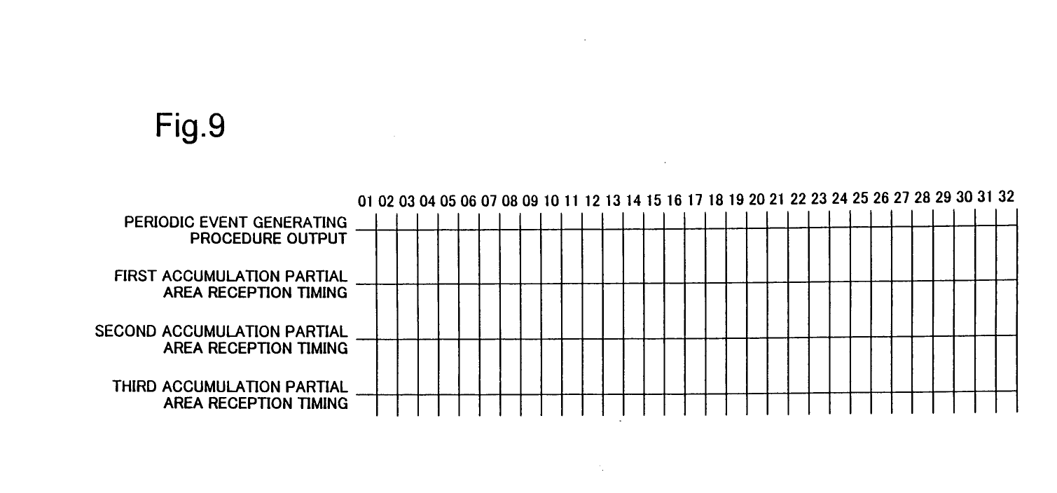

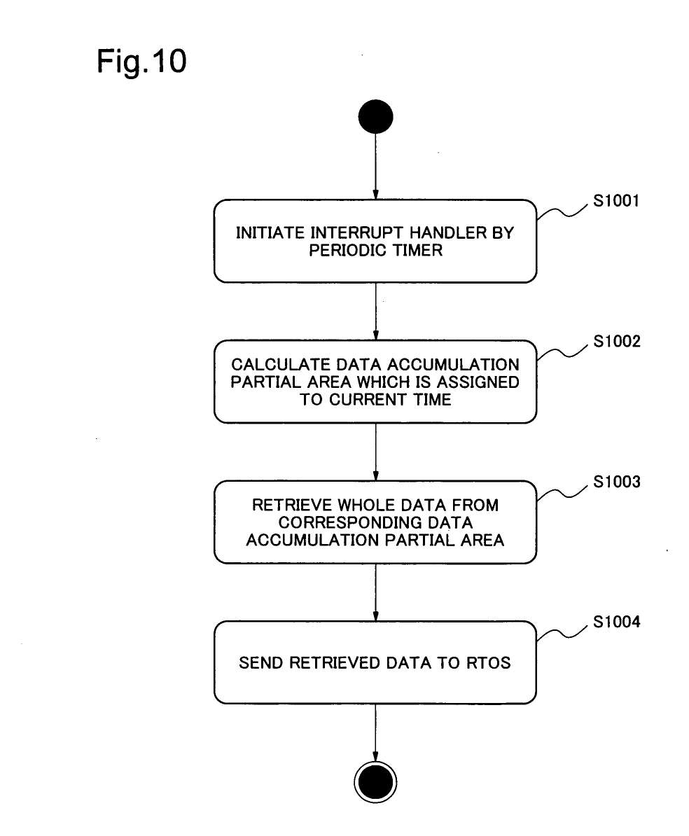

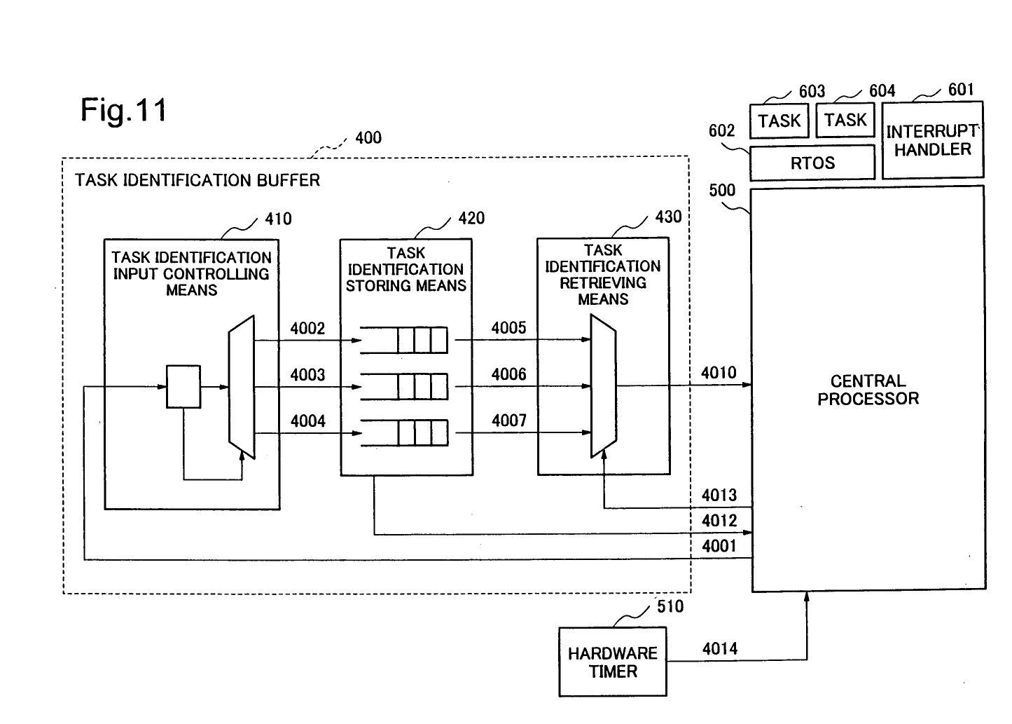

### DESCRIPTION OF THE CODES

100 first central processor
200 data communications processor
210 data input controlling means
211 data storage location selecting means
212 multiplexer for data storage
220 data accumulating means
221-223 data accumulation partial area
230 data retrieving means
231 multiplexer for data retrieve
240 reception timing creating means
241 periodic event creating means
242 signal count measuring means
243 storage area selection determining means
244 reception timing generating means
300 second central processor
400 task identification buffer
410 task identification input controlling means
420 task identification storing means
430 task identification retrieving means
500 central processor
510 hardware timer
601 interrupt handler
602 RTOS
603, 604 task
2001 data structure input signal
2002-2004 signal for data accumulation
2005-2007 accumulated data signal
2008 data accumulation partial area data count information signal
2009 multiplexer switching signal for data retrieve
2010 data output signal

1. A data communications processor, comprising:
a data accumulating unit which stores input data in a data accumulation partial area,
an input controlling unit which determines which of said data accumulation partial area that the input data to a plurality of said data accumulation partial areas,
a reception timing creating unit which generates a timing at a predetermined period, and
a data retrieving unit retrieves whole data which is included in one or plural said data accumulation partial areas for each timing generated by said reception timing creating unit.

2. The data communications processor according to claim 1,
wherein
said reception timing creating unit generates timings so that it may execute data receiving process at a different period for respective data accumulation partial area that are included in said data accumulating unit.

3. The data communications processor according to claim 2,
wherein
said reception timing creating unit generates so as a timing is not overlapped with each other for respective data accumulation partial area that are included in said data accumulating unit.

4. The data communications processor according to claim 3,
wherein
said reception timing creating unit generates the timing by a period of a multiple of two for respective data accumulation partial areas that are included in said data accumulating unit.

5. A data communications processing method, comprising:
distributing an inputted data to a plurality of groups based on the inputted deadline value,
accumulating the data that is distributed to said plurality of groups,
creating timings so as a period is a multiple of 2 and not overlap for each said plurality of groups, and
outputting whole data included in the group at said timing created where the timing created is related with the group.

6. (canceled)

7. (canceled)

8. A data communications processor, comprising:
data accumulating means for storing input data in a data accumulation partial area;
input controlling means for determining which of said data accumulation partial area that the input data is stored based on a inputted deadline value and for distributing input data to a plurality of said data accumulation partial areas;
reception timing creating means for generating a timing at a predetermined period; and
data retrieving means for retrieving whole data which is included in one or plural said data accumulation partial areas for each timing generated by said reception timing creating means.
